(19) United States
(12) Patent Application Publication
(10) Pub. No.: US 2023/0136071 A1
(43) Pub. Date: May 4, 2023

(54) SYSTEM AND METHOD FOR CYBER CAUSAL ATTRIBUTION VIA KOLMOGOROV COMPLEXITY

(71) Applicant: General Electric Company, Schenectady, NY (US)

(72) Inventors: Scott Charles EVANS, Burnt Hills, NY (US); Walter YUND, Clifton Park, NY (US); Saikat K. RAY MAJUMDER, Niskayuna, NY (US); Matthew Christian NIELSEN, Scotia, NY (US)

(21) Appl. No.: 17/514,071

(22) Filed: Oct. 29, 2021

(51) Int. Cl. G06K 9/62; G06K 9/00

(52) U.S. Cl. CPC G06K 9/6282; G06K 9/6296; G06K 9/6298; G06K 9/6226; G06K 9/0053

(57) ABSTRACT

Some embodiments provide a system and method comprising a memory and a processor to cause the system to: receive a first and second data distribution for a first and second variable, respectively; determine a first and second data optimum number of bins for the first and second data distribution, respectively; create a first and second model for the first and second data distribution using the first and second data optimum number of bins, respectively; apply the first model to the second data distribution to calculate a smallest descriptive size of the second data distribution given the first model; apply the second model to the first data distribution to calculate a smallest descriptive size of the first data distribution given the second model; and determine a causal direction between the first variable and the second variable based on the application of the first and second model. Numerous other aspects are provided.

### BACKGROUND

Industrial control systems that operate physical systems (e.g., associated with power turbines, jet engines, locomotives, autonomous vehicles, grid infrastructure, medical equipment (e.g., tools for ultra sounds, CAT scans, MRIs, etc.) etc.) are increasingly connected to the Internet. As a result, these control systems have been increasingly vulnerable to threats, such as cyber-attacks (e.g., associated with a computer virus, malicious software, etc.) that could disrupt electric power generation and distribution, damage engines, inflict vehicle malfunctions, etc. Current methods primarily consider attack detection in Information Technology (“IT,” such as, computers that store, retrieve, transmit, manipulate data) and Operation Technology (“OT,” such as direct monitoring devices and communication bus interfaces). Cyber-attacks can still penetrate through these protection layers and reach the physical “domain.” Such attacks can diminish the performance of a control system and may cause total shut down or even catastrophic damage to a plant. In some cases, multiple attacks may occur simultaneously (e.g., more than one actuator, sensor, or parameter inside control system devices might be altered maliciously by an unauthorized party at the same time). Note that some subtle consequences of cyber-attacks, such as stealthy attacks occurring at the domain layer, might not be readily detectable (e.g., when only one monitoring node, such as a sensor node, is used in a detection algorithm). Existing approaches to protect an industrial control system may include machine learning models which may help predict an attack. However, these approaches don't necessarily analyze a relationship between variables, which may be indicative of a cyber-attack. It would therefore be desirable to have additional systems and processes for automatically protecting a cyber-physical system from cyber-attacks.

### SUMMARY

According to some embodiments, a system is provided including a memory storing processor-executable steps; and a processor to execute the processor-executable steps to cause the system to: receive a first data distribution for a first variable; determine a first data optimum number of bins for the first data distribution; create a first model for the first data distribution using the first data optimum number of bins; receive a second data distribution for a second variable; determine a second data optimum number of bins for the second data distribution; create a second model for the second data distribution using the second data optimum number of bins; apply the first model to the second data distribution to calculate a smallest descriptive size of the second data distribution given the first model; apply the second model to the first data distribution to calculate a smallest descriptive size of the first data distribution given the second model; and determine a causal direction between the first variable and the second variable based on the application of the first model and the second model.

According to some embodiments, a method is provided including receiving a first data distribution for a first variable; determining a first data optimum number of bins for the first data distribution; creating a first model for the first data distribution using the first data optimum number of bins; receiving a second data distribution for a second variable; determining a second data optimum number of bins for the second data distribution; creating a second model for the second data distribution using the second data optimum number of bins; applying the first model to the second data distribution to calculate a smallest descriptive size of the second data distribution given the first model; applying the second model to the first data distribution to calculate a smallest descriptive size of the first data distribution given the second model; and determining a causal direction between the first variable and the second variable based on the application of the first model and the second model.

Some technical advantages of some embodiments disclosed herein are improved systems and methods to protect one or more cyber-physical systems (“CPS”) from abnormalities, such as cyber-attacks, in an automatic manner. Embodiments provide a causality module that determines an optimal number of bins in a histogram and uses this process to determine a causality direction in random variable pairs (e.g., does “X” cause “Y” or does “Y” cause “X”). Embodiments provide a causality module that is effective and efficient at determining causal directional relationships between sensor variables with the goal of identifying causal features for use in machine learning models, and noting shifts in causal relationships of windowed data in order to spot attacks, thereby providing increased cyber protection for the CPS. Embodiments may also reduce the computational complexity required to determine causality, as compared to conventional causal techniques, by a factor of 10, and improve the accuracy of the causal inference through improved compression. For example, conventional causal techniques may require more than ten seconds to determine an optimal binning scheme for a single variable of 1000 observations, which would not be practical for real time use. Embodiments, on the other hand, compute an optimal binning encoding for 1000 observations in less than ten milliseconds, depending on the level of quantization desired (i.e., if less precision is allowable, the algorithm can run faster). Embodiments may provide a causality algorithm that implements a dyadic (power of two) search for optimal binning, as well as a simplified method for encoding error costs. Embodiments provide for further computational efficiency by learning optimal histogram encodings/binnings offline and applying them online to a window of data, making real-time detection feasible through the use of a reduced window size. The causality module may also, in embodiments, provide for the creation of a grammar based code and the use of this code with time-series sequential data distributions to determine causality in random variable pairs, and determine optimal causal delay (e.g. X causes Y at a delay of 2 seconds). The use of the grammar based code may provide a means of applying this process on windowed data to enable real time detection of cyber-attacks These improvements, together, provide for the determination of causal relationships between variables in a cyber physical system, and the monitoring of these causal relationships to detect cyber-attacks.

With this and other advantages and features that will become hereinafter apparent, a more complete understanding of the nature of the invention can be obtained by referring to the following detailed description and to the drawings appended hereto.

Other embodiments are associated with systems and/or non-transitory computer readable mediums storing instructions to perform any of the methods described herein.

### BRIEF DESCRIPTION OF THE DRAWINGS

FIG. 1 is a high-level block diagram of a system according to some embodiments.

FIG. 2 illustrates a method according to some embodiments.

FIG. 3 illustrates a histogram and a graph according to some embodiments.

FIGS. 4A-4D illustrate two distributions according to some embodiments.

FIG. 5 illustrates a coding tree according to some embodiments.

FIGS. 6A-6D illustrate two distributions according to some embodiments.

FIG. 7 illustrates a non-exhaustive example according to some embodiments.

FIG. 8 illustrates a causal dependency matrix according to some embodiments.

FIG. 9 illustrates detection of a cyber attack according to some embodiments.

FIG. 10 illustrates a method according to some embodiments.

FIG. 11A and FIG. 11B illustrate a non-exhaustive example according to some embodiments.

FIG. 12 illustrates the non-exhaustive example of FIG. 11A and FIG. 11B according to some embodiments.

FIG. 13 is a block diagram of an apparatus according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, an industrial asset (e.g., power turbines, electric motors, aircraft engines, locomotives, hydroelectric power plants, grid infrastructure, medical equipment (e.g., tools for ultra sounds, CAT scans, MRIs, etc.)) with critical infrastructure may be operated by an industrial control system. As a result, a key challenge with these industrial assets is preventing a cyber-attack on the industrial control system by identifying and addressing any vulnerabilities in the system and/or quickly identifying an event as a cyber-attack. The cyber-attack may manipulate the system by changing sensor values, actuators (e.g., valves that affect the flow into a system), rotational speed, air flow, and/or by issuing false commands, etc. for the system.

Central to localizing cyber-attack vectors in control networks is determination of what sensor is the prime mover in a spoofing attack. Due to underlying physics, causal relationships will necessarily exist between some sensors. As a non-exhaustive example, temperature in one node will cause pressure in another node and vice versa. Some parameters may be more deterministically caused by some variables than others. However, when an attack occurs, these relationships may reverse or change in magnitude. Continuing with the non-exhaustive example, if the temperature at a given node in a gas network tends to causally determine the pressure at another node, and that temperature node is spoofed, the causal determination between pressure and temperature will for a time be disturbed. The control system may react to this disturbance, and restore causality in some sense, but until the control system catches up, a causal distortion may be observable, and this observation may be a means of localizing the attack. Methods for causality determination may include the use of Minimum Description Length (MDL) principles from the theory of Kolmogorov Complexity and Algorithmic Information Theory to infer causality. These methods utilize compression in some sense to estimate Kolmogorov Complexity, and to determine causal direction by quantifying the descriptive cost of one variable given another.

Embodiments apply the concept of Kolmogorov Complexity to sensor data to determine causal relationships between sensor variables by noting shifts in causal relationships of windowed data. These relationships may then be used to detect attacks. Compared to conventional Kolmogorov Complexity algorithms, which may not support continuous data types and thus lose the essence of the shape of data, embodiments provide a streamlined process to make the computation complexity tractable.

While machine learning models may help make predictions based on associations, they may not necessarily determine cause. A famous example is that ice cream consumption and drownings increase in the summer, but eating ice cream does not cause you to drown. In other words, correlation is not causation. One or more embodiments determine whether variable X determines variable Y or vice versa. In terms of cyber-security, if someone is spoofing a sensor so that it appears to be sending incorrect pressure values, for example, in a case that the pressure causes temperature in another part of the system, the temperature may not change in response to the spoof, which in turn may indicate an attack exists, and may help to indicate the location of the attack. Embodiments may determine whether variable X determines variable Y or vice versa, and then identify an inversion of the relationship.

Additionally, use of the method described herein to identify causal relationships may also be used as a means of feature selection for traditional machine learning techniques, where only highly causal features are utilized as inputs. As a non-exhaustive example, if you have 1000 features, the method described herein may be used to determine that twenty of those 1000 features are the most causal features in terms of predictions. Then the machine learning model may be built from those twenty features.

The present invention provides significant technical improvements to facilitate causality determinations between variables and cyber attack detection. The present invention is directed to more than merely a computer implementation of a routine or conventional activity previously known in the industry as it significantly advances the technical efficiency between devices by implementing a specific new method and system as defined herein. The present invention is a specific advancement in the area of directional causality and cyber detection by providing benefits in reduced computational complexity, improved accuracy, and detection and localization of a cyber-attack, and such advances are not merely a longstanding commercial practice. The present invention provides improvement beyond a mere generic computer implementation as it involves the processing and conversion of significant amounts of data in a new beneficial manner.

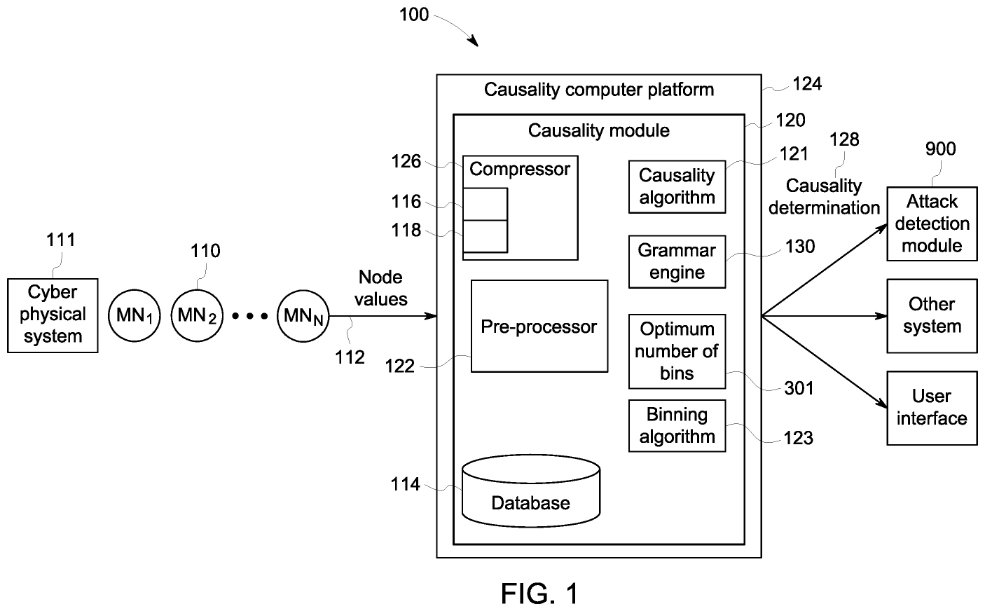

FIG. 1 is a high-level block diagram of a system 100 that may be provided in accordance with some embodiments. The system 100 includes monitoring nodes 110, such as sensors, actuators and controller parameters that generate a series of current monitoring node values 112 over time that represent a current operation of a cyber-physical system 111 (e.g., an industrial asset). The monitoring node values 112 may be transmitted via an information system. For example, the information system may be a communication network such as, for example, an intranet or the Internet. In such embodiments, the input data stream may comprise packetized digital information such as, for example, digital information provided in accordance with the Transport Control Protocol/Internet Protocol (TCP/IP), the HyperText Transport Protocol (HTTP), the Simple Mail Transport Protocol (SMTP), or the Uniform Datagram Protocol (UDP). In some embodiments, the series of current monitoring node values 112 may be a sequential data stream.

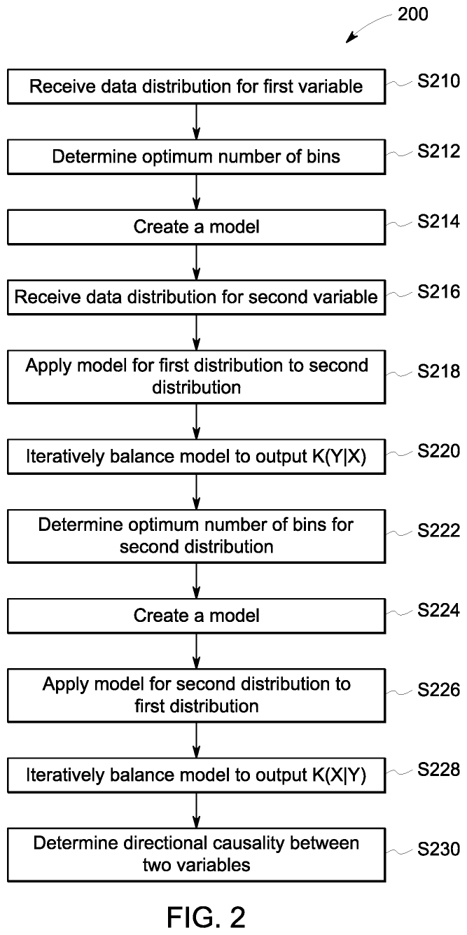

The system 100 may also include a causality module 120 configured for causality determination and including a pre-processor 122 and a compressor 126. The causality module 120 of a causality platform 124 may generate a causality determination 128 for two variables. The causality determination 128 may be the determination that one variable in a system causes another random variable. In one or more embodiments, this determination may be made using a minimum description length binning/histogram process, described further below with respect to FIG. 2. According to various embodiments, the pre-processor 122 may be configured to receive input data (node values) 112, which may be an input data stream, and be configured to output filtered data to the compressor 126. The compressor 126 may be configured to generate a compressed size of the input data using a compression algorithm.

The pre-processor 122 may also be configured to apply a sliding window protocol to the input data/stream that segments or divides the input data stream into discrete or separate portions of sequential information. Input data streams of various lengths may be supported such as, for example, input data streams of at least 1 KB in length. In various embodiments, the pre-processor 122 may filter the input data stream 112 by removing from consideration input data known to not be useful for determining causality.

In one or more embodiments, the compressor 126 may be configured to perform a Minimum Description Length (MDL) Compression (MDLcompress) algorithm to generate a grammar based code that estimates the Kolmogorov complexity of a variable. It is noted that MDLcompress may achieve general compression of a variable by creating a grammar and using that “grammar based code” to compress the variable. As used herein, the term “grammars” refers to a set of rules and relationships that are associated with particular data sequences. Additionally, the term “model” or “compression model” as used herein may refer to a set of one or more grammars with a probability distribution being associated with each grammar.

The system 100 may also include a database 114. Database 114 may store data used by at least the causality module 120. For example, database 114 may store data values (e.g., sensor values, training values, etc.) that may be used by the causality module 120 during the execution thereof.

Database 114 may comprise any query-responsive data source or sources that are or become known, including but not limited to a structured-query language (SQL) relational database management system. Database 114 may comprise a relational database, a multi-dimensional database, an eXtendable Markup Language (XML) document, or any other data storage system storing structured and/or unstructured data. The data of database 114 may be distributed among several relational databases, dimensional databases, and/or other data sources. Embodiments are not limited to any number or types of data sources.

In some embodiments, the data of database 114 may comprise one or more of conventional tabular data, row-based data, column-based data, and object-based data. Moreover, the data may be indexed and/or selectively replicated in an index to allow fast searching and retrieval thereof. Database 114 may support multi-tenancy to separately support multiple unrelated clients by providing multiple logical database systems which are programmatically isolated from one another.

Database 114 may implement an “in-memory” database, in which a full database is stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

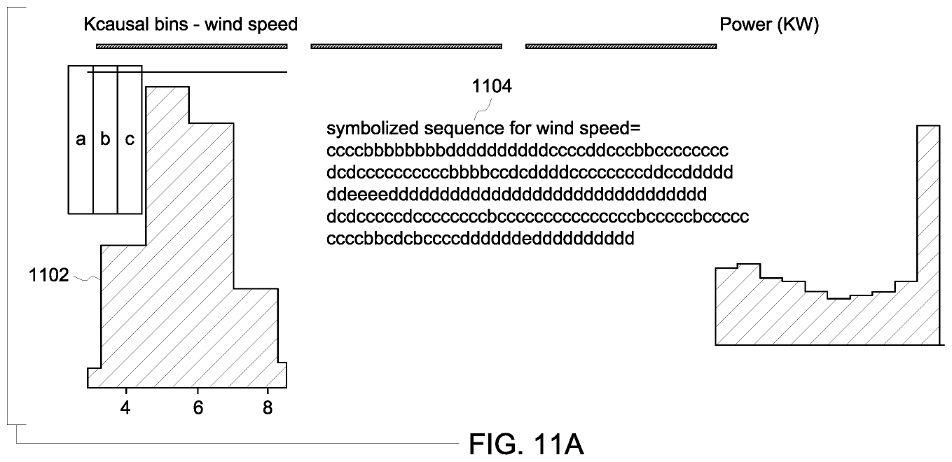

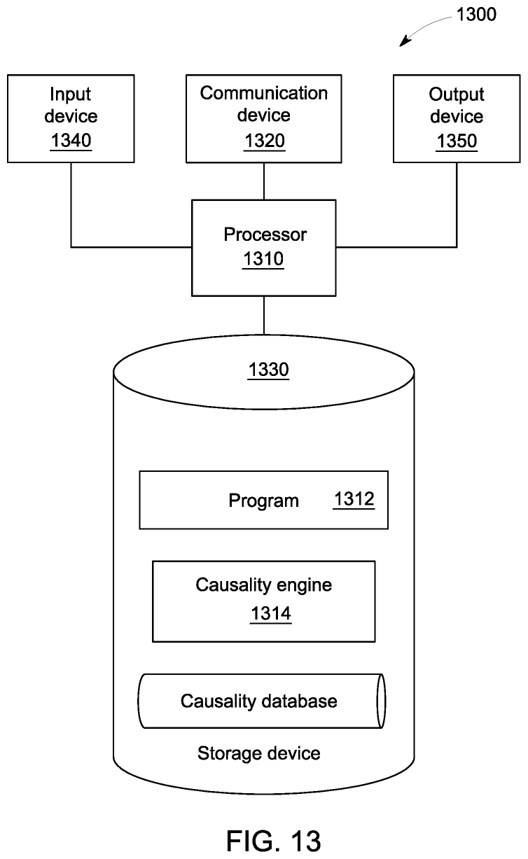

FIGS. 2 AND 10 are methods that may be provided in accordance with some embodiments. Processes 2 and 10 may be executed by the architecture 100 according to some embodiments. In one or more embodiments, the architecture 100 may be condition to perform the processes 200/1000, such that a processor 1310 (FIG. 13) of the system 100 is a special purpose element configured to perform operations not performable by a general-purpose computer or device. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S210, a first data distribution 116 for a first variable (“X”) may be received from a first monitoring node 110 as a series of continuous current monitoring node values 112. The distribution may be time dependent or non-time dependent. It is noted that while the grammar-based method, described further below, may be better at determining causality in time dependent variables, the histogram method described herein may also be used to determine causality by applying the histogram on moving time windows.

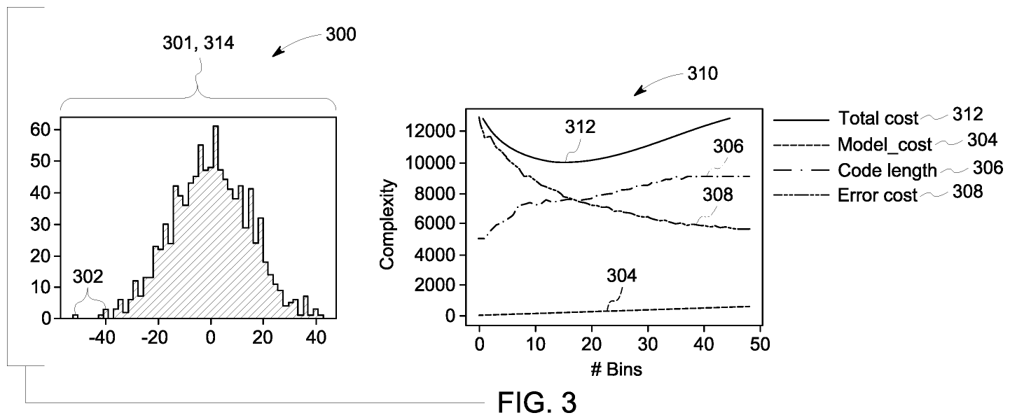

Then at S212 an optimum number of bins 301 (FIG. 3) to describe the first data distribution 116 is determined. In embodiments, the causality module 120 may be configured to execute a binning algorithm 123 to determine the optimum number of bins. In embodiments, a dyadic (power of two) formulation of the binning algorithm 123 may search for optimal binning, which includes an optimal histogram binning of a variable as 1 bin, 2 bins, 4 bins, 16 . . . up to 2″ bins. Then, a binary search between optimal bins to further refine the process may also be implemented via a type of entropy coding, including, but not limited to, Huffman coding, Shannon coding, and arithmetic coding, as described further below.

In some embodiments, the optimum number of bins 301 may be the smallest binning partition that describes the data distribution. As described herein, the optimum number of bins (e.g., smallest compressed size of “X”, where “X” represents the first variable) may be referred to as K(X), where “K” is the Kolmogorov complexity (i.e., minimum length of a program such that a universal computer can generate a specific sequence). The K(X) may be determined via a Markov Decision Process (MDP), or any other suitable optimization processes may be used. The causality module 120 may extract bin frequencies and compute Shannon codes for the extracted bin frequencies. Shannon coding is a variable length encoding technique for lossless data compression, whereby a code is assigned to a symbol based on their probabilities of occurrence and the codes assigned to the symbols will be of varying length. Data compression, also known as source coding, encodes or converts data in such a way that it consumes less memory space, thereby reducing the number of resources required to store and transmit data. In one or more embodiments, an entropy (e.g., a Shannon code or similarly a Huffman Code) may be calculated for: 1. a model cost 304, as the total number of bins and a code length for each bin; 2. a code length cost 306, where for each point, an entropy code is encoded for the bin the point belongs to; and 3. an error cost 308, where for each point, an entropy code is encoded for the error between the point's value and a mean of all points in the bin. For example, as shown in FIG. 3, a histogram 300 is provided for a first continuous data distribution 302, having a plurality of bins 304 for 1,000 points, with a standard deviation of 20. FIG. 3 also includes a graph 310 to determine the optimum binning for that distribution 116. In determining the optimum number of bins 301, there may be a trade-off between model cost 304 (cost to describe the number of bins), code length cost 306 (code length in the bins) and error cost 308. It is noted that as the number of bins increase, the error cost 308 may decrease because the distribution is being described more precisely, while the code length (probability) cost 306 may increase as a code is needed for each bin. For example, in a case that bin 5 includes five members, this translates into a particular code length because the 5 members in the bin can be converted to a probability by dividing by the total number of observations. The probability is the probability of an observation being a member of that particular bin. For example, if there are 100 observations and five bins, with ten members in bin 1, twenty members in bin 2, thirty members in bin 3, twenty members in bin 4, and twenty members in bin 5, the probability of an observation being in each bin is 0.1, 0.2, 0.3, 0.2 and 0.2, respectively. As the number of members in a bin increase, a smaller code length is used because descriptive costs are less since one bin is applied to more members. It is additionally noted that as the number of bins increases, the model cost 304 may increase. A total cost 312 may be the sum of the model cost 304, the code length cost 306 and the error cost 308. The minimum of the total cost 312 may be the value that is deemed to be optimal for determining the complexity of X or Y. The minimum total cost may then be mapped to an optimal number of bins.

For example, FIG. 3 shows the optimal Minimum Description Length (MDL) binning 301 at various bin sizes as determined by the dyadic formulation of the binning algorithm 123. As shown herein, the Model Costs 304 (which describe the number of bins needed and the code-lengths that will be required to identify an observation occurs in a specific bin) are traded off with the Data Costs/Code Length Costs 306 (costs of encoding each observation) and Error Costs 308 (which enable recovery of the exact distribution to the accuracy defined by a quantization level). The binning algorithm 123 minimizes the sum of these terms.

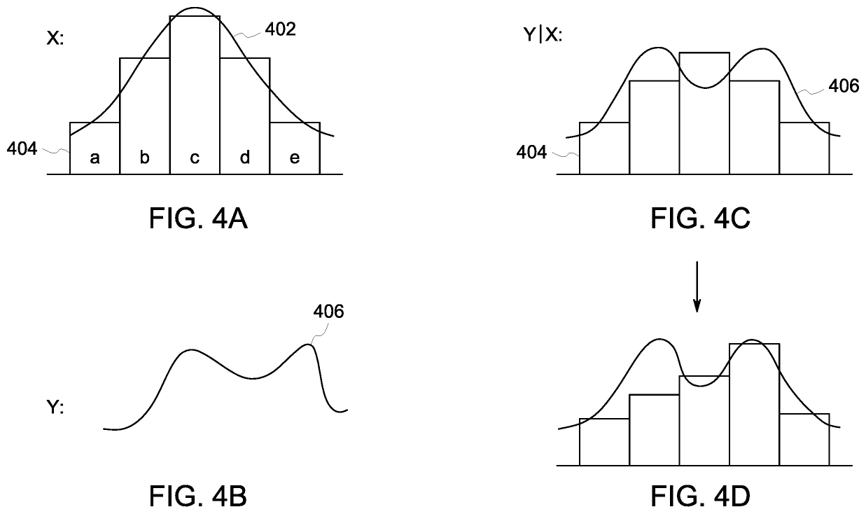

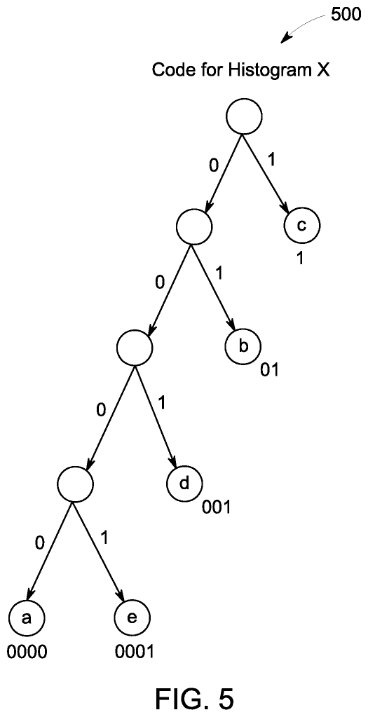

After the optimum number of bins 301 to describe the first data distribution 116 is determined in S212, a model 314 is created for the first data distribution 116 using the optimum number of bins in S214. The model 314 may be a histogram, or any other suitable model. As shown in FIG. 4A, the first data distribution 116 for variable “X”, represented by the line 402, is created as an optimized histogram model 404, having five bins labeled a, b, c, d and e. It is noted that “c” has the largest number of members (because it is the tallest bar), so it also has the smallest code length. Similarly, the tails of the model (“a” and “e”) have higher code lengths because they have the least members. The model 404 of the first distribution for variable “X” may also be represented as a code, as shown by the coding tree 500 in FIG. 5. Bin “c” includes the most members, so it is assigned the smallest code “1” and code length “1”, which also represents the number of bits “1”. Bin “b” for example, includes the second most members, is assigned a code of “01”, and has a code length of “2” (2 bits). Bin “d” includes the third most members, is assigned a code of “001”, and has a code length of “3” (3 bits). Bins “a” and “e” each include a same number of members, which is the fourth most members, and are assigned a code of “0000” and “0001”, respectively, each having a code length of “4” (4 bits).

The encoding (e.g., model) of the optimal number of bins determined in S214 may then be applied to a second data distribution 118 for a second variable (“Y”) to determine causality (i.e., whether the first causes the second or vice versa). To that end, in S216, a second data distribution 118 for a second variable (“Y”) may be received from a second monitoring node 110 as a series of continuous monitoring node values 112, represented in FIG. 4B by the line 406.

It is noted that, in some embodiments, causality may be determined between two variables during an offline learning phase. Then, during an online detection phase, one of the models may be applied (e.g., the model for the first distribution is applied to the second distribution) to avoid the computational costs associated with generating a second model.

Next, the model 404 created for the first data distribution 402 is applied to the second data distribution 406 in S218, as shown in FIG. 4C, to calculate the descriptive costs for the second data distribution. This may be referred to as determining the Kolmogorov complexity of Y given X (K(Y|X)). Kolmogorov Complexity is a measure of descriptive complexity contained in an object, which refers to the minimum length of a program such that a universal computer can generate a specific sequence. Thus, knowledge or input of a string X may reduce the complexity or program size necessary to produce a new string Y. In one or more embodiments, application of a model to a data distribution may include fitting the model to the distribution.

In some instances, the model for the first data distribution may not be efficiently applied to the second data distribution, and as such may not be optimal. For example, as shown in FIG. 4C, there is a mismatch between the model 404 and the distribution 406, as the model does not exactly fit to the data distribution. and a better fit of the model 404 to the distribution 406 would have smaller code lengths for bin “b” and bin “d”, but the model 404 forces the use of smaller code lengths on the other bins. To address this inefficiency, the model may be iteratively balanced on a starting point, as shown in FIG. 4D such that the model 404 is modified to better fit the second distribution in S220 (e.g., the code lengths of the bins may be iteratively balanced to better fit the second data distribution). The output of this modification may be referred to as the Kolmogorov complexity of “Y” given “X”, represented by K(Y|X). For example, one or more descriptive costs (e.g., model costs 304) for the model 404 may be modified to provide a better fit to the second data distribution 406. The modification may include the re-assignment of code lengths, such that the model 404 is slightly modified. With respect to FIG. 4D, the code length of bin “c” was swapped with bin “d”. In one or more embodiments, the algorithm determines how to adjust code lengths by seeking re-assignments that lead to greatest overall compression. The algorithm may then compare the cost of describing alterations to the partition against compression gain in doing the swap to iterate to a better model. In some embodiments, more than one iteration may be executed, and the causality module 120 may track the complexities at each iteration and assign K(Y|X) as the minimum in a case of the final iteration. The final iteration may be determined when remaining iterations no longer contribute (for example, the total cost in terms of bytes stops decreasing with each successive iteration.

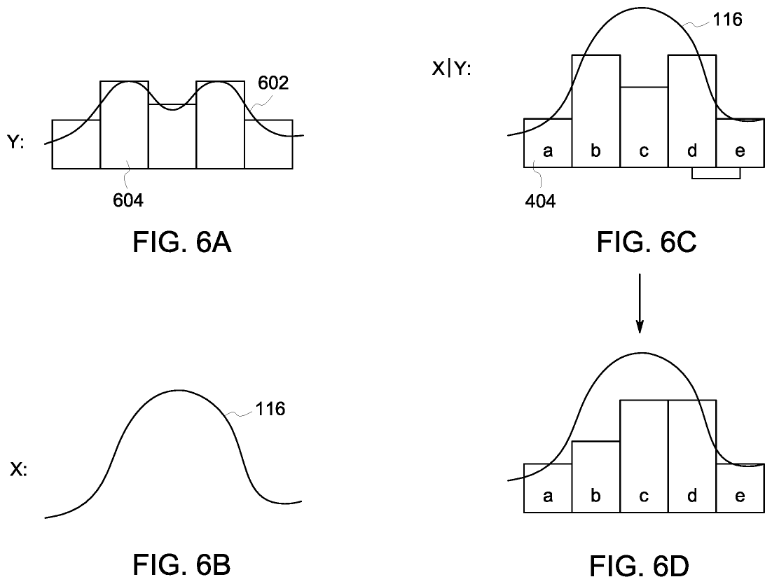

After K(Y|X) is determined at S220, the binning algorithm 123 may in S222 determine an optimum number of bins to describe the second data distribution 118 for the second variable (“Y”), in a same manner as described above in S212 for determining the optimum number of bins to describe the first data distribution for the first variable (“X”). Then, in S224, a model is created for the second data distribution using the optimum number of bins determined for the second distribution in S222 in a manner, as described above for the model created for the first data distribution in S214. For example, as shown in FIG. 6A, the second data distribution 118 for the second variable, represented by the line 602, is created as an optimized histogram model 604, having five bins labeled a, b, c, d and e.

The first data distribution 116 for the first variable (“X”) is shown in FIG. 6B, and then in S226, the model 604 created for the second data distribution 602 is applied to the first data distribution 116, as shown in FIG. 6C, to calculate the descriptive costs for the first data distribution. This may be referred to as determining the Kolmogorov complexity of X given Y (K(X|Y)). As described above with respect to FIG. 4D, there may be a mismatch between the model 604 and the distribution 116, as shown in FIG. 6D and a better fit of the model 604 to the distribution 116 would have smaller code lengths for bin “c” and a larger code length for bin “b” and bin “d”. To address this inefficiency, the model may be iteratively balanced on a starting point, as shown in FIG. 6D such that the model is modified to better fit the first distribution in S228 (e.g., the code lengths of the bins may be iteratively balanced to better fit the second data distribution).

It is noted that while S222-S228 is described as occurring after S210-S220, these processes may be occurring at a same time or at a substantially same time.

Next, in S230, the causality module 120 executes the causality algorithm 121 to determine whether the first variable (X) caused the second variable (Y) or vice versa. In a case that K(X)+K (Y|X) is less than K(Y)+K (X|Y), then the first variable (X) caused the second variable (Y). In a case that K(Y)+K (X|Y) is less than K(X)+K (Y|X), then the second variable (Y) caused the first variable (X).

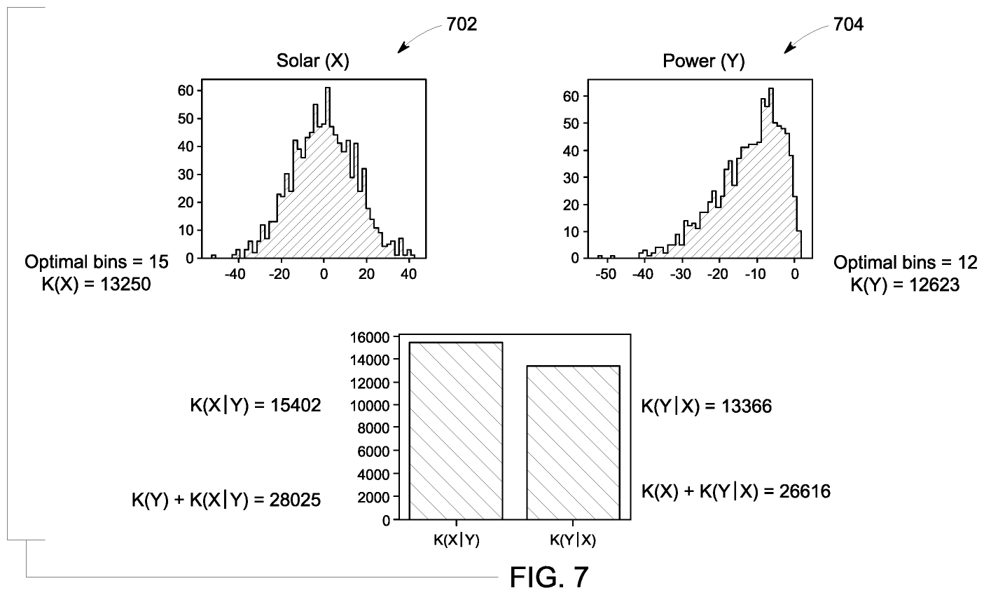

A non-exhaustive example in the field of Solar Power may be used to describe the process 200 detailed herein. The non-exhaustive example, as shown in FIG. 7 may be that solar intensity causes solar power as output from solar panels. The output power from solar panels is highly correlated to the solar intensity incident on solar panels. However, from first principles, the prime causal mover is the solar intensity, resulting in the electric power produced by the panels. The application of the causality algorithm 121 applied to a solar data set and a power data set shows this to be true and that there is more information in the histogram of solar intensity that is able to help compress the histogram of the solar power output than vice versa.

In the example, treating the solar distribution as the first data distribution for the first variable (X), the optimal number of bins for the solar distribution is determined to be 15, with a complexity (K(X)) of 13250, determined at S212, and the model 702 is determined per S214. The complexity (K(Y|X)) of power (Y) given solar (X) is determined to be 13366 at S218. Although not shown herein, one or more iterations may have been performed per S228.

Then, treating the power distribution as the second data distribution (Y), the optimal number of bins for the power distribution is determined to be 12, with a complexity (K(Y)) for the second variable of 12623, as determined at S222. A model for the power distribution 704 is generated at S224. The complexity (K(X|Y)) of solar (X) given power (Y) is determined to be 15402 at S226. The causality module 120 then executes the causality algorithm 121 at S230

K(Solar)+K(Power|Solar)<K(Power)+K(Solar|Power)

13250+13366<12623+15402

to determine that solar intensity causes solar power and not vice versa.

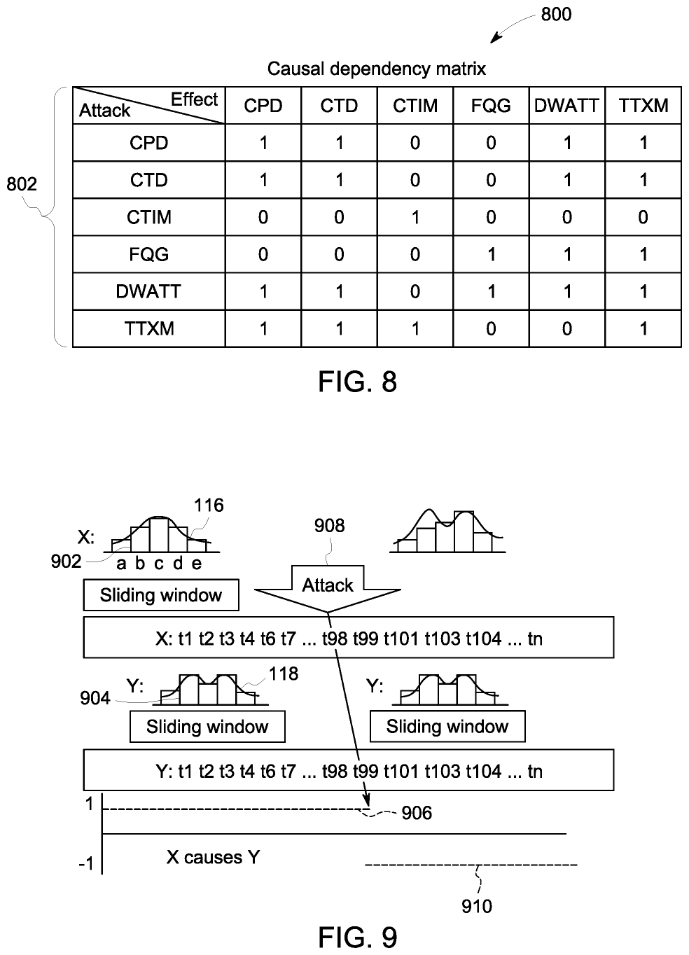

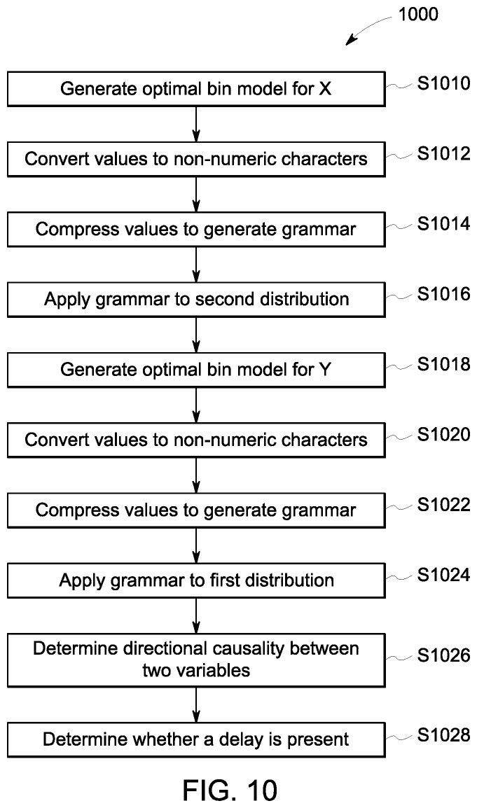

In one or more embodiments, the causality module 120 may, in an offline environment, generate a causal dependency matrix 800 (FIG. 8) and time windows for a plurality of variables associated with a CPS. The causal dependency matrix 800 may identify key causal features and may provide a fast inference or look-up of causal direction in a real-time/online environment. For example, the causal dependency matrix 800 in FIG. 8 includes variables 802 for a gas turbine. The variables include, but are not limited to CPD (pressure), CTD (temperature), DWATT (power), etc. In the non-exhaustive example of the matrix 800 shown herein, a “1” indicates the column causes the row. As such, CPD causes CDT; and CTIM causes TTXM. The inventors note that causality may move in both directions, and two variables may equally affect each other. In one or more embodiments, the causality determinations included in the matrix may be verified by a subject matter expert and used during a machine learning/training process to generate a model to detect an attack in real-time via causal inversion, for example, as described further below with respect to FIG. 9. Any suitable machine learning method may be used, including, but not limited to linear regression, polynomial models, generalized linear models, extreme learning machine (ELM) regression and deep neural networks. It is noted that the matrices/windows may be dependent upon specific pipeline operating conditions which may each be modeled ahead of time, and the machine learning/training process may require large amounts of training data. For example, load sweep data analyzed from a normally operating CPS simulation (i.e., no attacks, faults or anomalies) may be used to construct a causality matrix. There may be variables that are highly dependent (caused by many other variables and are prime mover causes of a few), and it may be desirable to create a machine learning model based on features that are causal rather than dependent. In view thereof, embodiments may provide for the extraction of ranked causalities, which may be verified during a training process.

In one or more embodiments, the causality module 120 may, in an online/near-real-time environment, generate a causal matrix from current pipeline configuration/operations conditions without a significant pre-construction of a causal matrix. For example, the model may be applied to current operating conditions for a specific variable without creating a causal matrix for all of the variables associate with the CPS.

Turning to FIG. 9, an attack detection module 900 may be configured to detect an attack on a CPS in real-time via causal inversion. As shown herein, the models 902, 904 are created for a first data distribution 116 and a second data distribution 118, respectively, and it has been determined that for normal operation of the CPS, the first variable (X) causes the second variable (Y), as indicated in FIG. 9 by the line 906 at “1” as this represents normal operation of the CPS. At time t99, an attack 908 on the CPS is experienced, and the data values inserted by the attack show a causal inversion resulting in the second variable (Y) appearing to cause the first variable (X), as indicated by the line 910 at “−1”. The attack detection module 900 detects the attack 908 at t99 in response to the inversion of the causality and may at least one of issue a notification and execute a corrective action. As a non-exhaustive example, pressure (X) causes temperature (Y) for a particular CPS, and an indicator of an attack on the temperature gauge may be evident by temperature values that are not caused by pressure (e.g., pressure has stayed constant, but temperature has changed; or temperature has not changed in the expected way with changes in pressure).

In one or more embodiments, the causality module 120 may apply a grammar engine 130 to a sequential time series of data prior to application of the causality algorithm 121. In some embodiments, the grammar engine 130 may find patterns and motifs useful for compressing unknown data sets via a grammar-based Minimum Description Length (MDL) compression algorithm (“compressor”) 126 to generate grammars. The compressor 126 may use a grammar-based coding technique that compresses through inferring an algorithmic minimum sufficient statistic in a stochastic gradient manner. As used herein, the term “grammars” refers to a set of rules and relationships that are associated with particular data sequences. Furthermore, the term “compression model” as used herein refers to a set of one or more grammars with a probability distribution being associated with each grammar. After the grammar code is generated, the causality algorithm 121 may be applied, as described above, to the grammar code to determine a causality direction (i.e., does X cause Y or does Y cause X) between two variables.

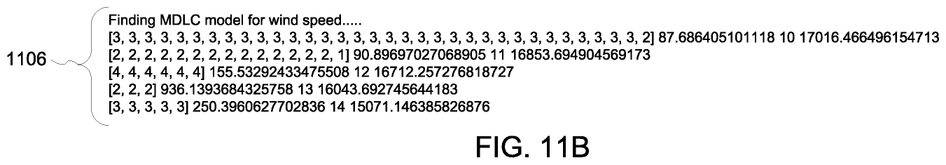

The grammar process 1000 (FIG. 10) may be described with respect to another non-exhaustive example, illustrated in FIG. 11A and FIG. 11B. Namely, two variables may be wind speed (X) and wind turbine power (Y), and the causality algorithm 121 together with the grammar engine 130 may be used to answer the question: does wind speed cause wind turbine power? As described above with respect to S225 of FIG. 2, an optimal bin model 1102 for a wind speed distribution is generated at S1010. Then the grammar engine 130 may convert the values in the model 1102 to a non-numeric characters 1104 in S1012. It is noted that other suitable quantization of the data distribution may be used to generate values for conversion in S1012, instead of the optimal bin model of S1010. After the non-numeric character sequence 1104 is generated in S1012, the sequence 1104 may be compressed to find the smallest grammar (K(X)) 1106 in S1014 via MDL Compression as shown in FIG. 11B. In embodiments, the compressor 126 may use a grammar-based coding technique that compresses through inferring an algorithmic minimum sufficient statistic in a stochastic gradient manner, referred to herein as MDL compression. As described above, MDL is related to Kolmogorov Complexity, a measure of descriptive complexity contained in an object, which refers to the minimum length of a program such that a universal computer can generate a specific sequence. Thus, knowledge or input of a string X may reduce the complexity or program size necessary to produce a new string Y. The MDL compression may provide the capability to identify strings of significant sequences for MDL while bounding the amount of computational resources required. For example, FIG. 11B provides the MDLC model for wind speed. With each successive iteration, the K(X) estimate is the right-most number, and is decreasing from 17016. to 16853 to 16712 to 16043 and finally to 15071 in the last iteration.

Next in S1016, the grammar is applied to the data distribution for the second variable—wind power (Y), and the wind power sequence is compressed using the grammar to generate K(Y|X), as in S226 of FIG. 2. In one or more embodiments, as part of the compression process, the grammar may be used recursively in other iterations, whereby at least one grammar rule may be built on to create another grammar rule. As a non-exhaustive example,

Consider the string “a_rose_is_a_rose_is_a_rose”

A single first grammar rule could capture the phrase:

S1->“a_rose”

Resulting in the string: S1_is_S1_is_S1

The Recursive nature of MDLcompress would create an additional rule:

S2->S1_is, resulting in the final string S2S2S1

The process of S1010-S1016 is repeated for the wind power variable (Y) as in S222-S228 of FIG. 2. For example, in S1018, a optimal bin model for “Y” is generated; in S1020 the values of the optimal bin are converted to non-numeric characters; in S1022 the sequence of non-numeric characters is compressed to generate a grammar, in S1024 the grammar is applied to the first distribution.

Then the direction of causality is determined in S1026, as in S230, described above. In particular, if K(X)+K(Y|X)<K(Y)+(K(X|Y), it is inferred that X causes Y.

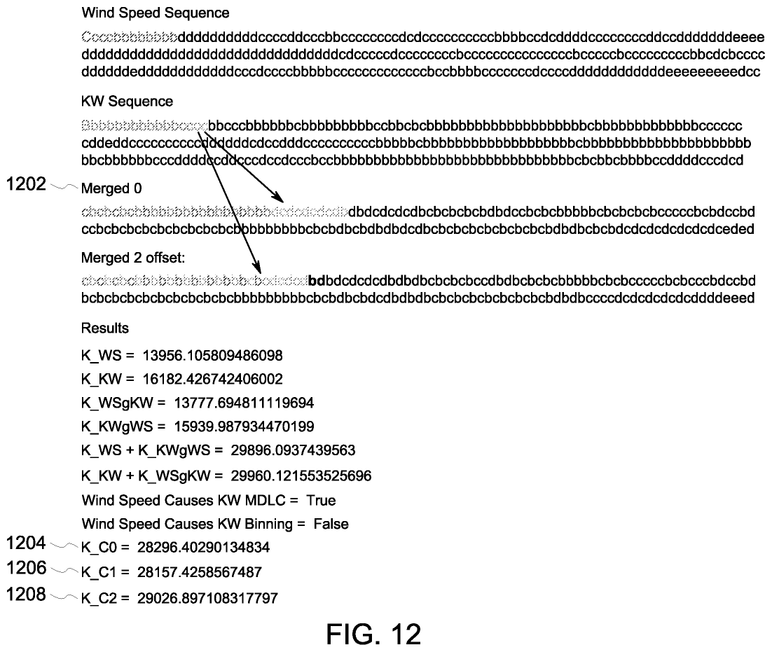

In one or more embodiments, it may further be determined at S1028 whether a delay is indicated by the data distribution. To determine whether there is a delay, two data sets may be merged 1202, as shown in FIG. 12, with the merger of the wind speed sequence and the kilowatt sequence. After the merger, the Kolmogorov Complexity for the merged data set 1202 is determined, as described above with respect to steps S210-S214. In some embodiments, delays of different times (e.g., 0 delay, 1 delay, 2 delay, etc.) are interleaved, and then the resulting merged files are compressed. The delay resulting in maximal compression (e.g., which K(X) is the smallest value) is flagged as optimal. The Kolmogorov Complexity for the originally merged data set may be a value with zero delay. As shown in FIG. 12, the zero delay (K_C0) 1204 has a value of 28296.40290134834. Then a one second offset/delay may be interleaved in the merged data set 1202. As shown in FIG. 12, the one second offset/delay (K_C1) 1206 has a value of 28157.4258567487. A two second offset/delay may also be interleaved in the merged dataset 1202. As shown in FIG. 12, the two second offset (K_C2) 1208 has a value of 29026.897108317797. For the non-exhaustive example shown in FIG. 12, the optimal delay occurs with the one second offset (K_C1), as this is the smallest Kolmogorov Complexity and therefore the minimum length needed for a program. It is noted that the delay between random variables may be indicative of causal influence. For example, if X causes Y at a delay of 1, with the following relationships:

| | |
|---|---|
| X | Y |
| A | Z |
| B | Q |
| C | Y |
| D | R |
| E | F |

The merged sequence of X=ADABACADABAD and Y=_ZRZQZYZRZQZR at delay of 1 provides sequence AZDRAZBQAZCYADRAZBQAZDR which has all causal pairs that will compress well, compared to other delays.

Note that the embodiments described herein may be implemented using any number of different hardware configurations. For example, FIG. 13 is a block diagram of a causality platform 1300 that may be, for example, associated with the system 100 of FIG. 1, and/or any other system described herein. The causality platform 1300 comprises a processor 1310, such as one or more commercially available Central Processing Units (“CPUs”) in the form of one-chip microprocessors, coupled to a communication device 1320 configured to communicate via a communication network (not shown in FIG. 13). The communication device 1320 may be used to communicate, for example, with one or more remote monitoring nodes, user platforms, digital twins, etc. The causality platform 1300 further includes an input device 1340 (e.g., a computer mouse and/or keyboard to input causality parameters and/or modeling information) and/an output device 1350 (e.g., a computer monitor to render a display, provide alerts, transmit recommendations, and/or create reports). According to some embodiments, a mobile device, monitoring physical system, and/or PC may be used to exchange information with the causality platform 1300.

The processor 1310 also communicates with a storage device 1330. The storage device 1330 may comprise any appropriate information storage device, including combinations of magnetic storage devices (e.g., a hard disk drive), optical storage devices, mobile telephones, and/or semiconductor memory devices. The storage device 1330 stores a program 1312 and/or causality engine 1314 for controlling the processor 1310. The processor 1310 performs instructions of the programs 1312, 1314, and thereby operates in accordance with any of the embodiments described herein. For example, the processor 1310 may receive from the nodes a first distribution for a first variable and a second distribution for a second variable, where the first variable is different from the second variable, and then apply the causality algorithm to determine a direction of causality between the two variables.

The programs 1312, 1314 may be stored in a compressed, uncompiled and/or encrypted format. The programs 1312, 1314 may furthermore include other program elements, such as an operating system, clipboard application, a database management system, and/or device drivers used by the processor 1310 to interface with peripheral devices.

As used herein, information may be “received” by or “transmitted” to, for example: (i) the causality platform 1300 from another device; or (ii) a software application or module within the causality platform 1300 from another software application, module, or any other source.

Although specific hardware and data configurations have been described herein, note that any number of other configurations may be provided in accordance with embodiments of the present invention (e.g., some of the information associated with the databases described herein may be combined or stored in external systems). Moreover, although some embodiments are focused on gas turbines, or solar/wind systems any of the embodiments described herein could be applied to other types of cyber-physical systems including power grids, dams, locomotives, airplanes, and autonomous vehicles (including automobiles, trucks, drones, submarines, etc.)

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A system comprising:
a memory storing processor-executable steps; and
a processor to execute the processor-executable steps to cause the system to:
receive a first data distribution for a first variable;
determine a first data optimum number of bins for the first data distribution;
create a first model for the first data distribution using the first data optimum number of bins;
receive a second data distribution for a second variable;
determine a second data optimum number of bins for the second data distribution;
create a second model for the second data distribution using the second data optimum number of bins;
apply the first model to the second data distribution to calculate a smallest descriptive size of the second data distribution given the first model;
apply the second model to the first data distribution to calculate a smallest descriptive size of the first data distribution given the second model; and
determine a causal direction between the first variable and the second variable based on the application of the first model and the second model.

2. The system of claim 1, wherein the optimum number of bins includes a model cost, a code length and an error cost.

3. The system of claim 1, further comprising processor-executable steps to cause the system to:
determine a source of the first data distribution is under attack or a source of the second data distribution is under attack based on the determined causal direction.

4. The system of claim 1, wherein application of the first model to the second data distribution and application of the second model to the first data distribution is via a Kolmogorov complexity algorithm.

5. The system of claim 4, wherein:
the application of the first model to the second data distribution fits the first model to the second data distribution; and
the application of the second model to the first data distribution fits the second model to the first data distribution.

6. The system of claim 1, wherein the direction of causality is determined to be:
the first variable causes the second variable in a case that:
K(X)+K(Y|X)<K(Y)+K(X|Y); and
the second variable causes the first data variable in a case that:
K(X)+K(Y|X)>K(Y)+K(X|Y);
wherein K(X) is the first data optimum number of bins, K(Y|X) is an output of the application of the first model to the second data distribution, K(Y) is the second data optimum number of bins, and K(X|Y) is an output of the application of the second model to the first data distribution.

7. The system of claim 1 wherein the first data distribution and the second data distribution are provided by a cyber-physical system.

8. The system of claim 1, wherein the first data distribution is a time series and the second data distribution is a time series.

9. The system of claim 8, further comprising, prior to application of the first model and application of the second model, processor executable steps to cause the system to:
convert one or more values in the first model to non-numeric characters;
compress the first model non-numeric characters to generate a first model smallest grammar;
convert one or more values in the second model to non-numeric characters; and
compress the second model non-numeric characters to generate a second model smallest grammar.

10. The system of claim 9, wherein application of the first model further comprises application of the first model smallest grammar to the second model non-numeric characters to calculate the smallest descriptive size of the second data distribution given the first model smallest grammar.

11. The system of claim 9, wherein the compression is via a grammar-based minimum description length (MDL) algorithm.

12. The system of claim 10, wherein application of the first model smallest grammar to the second model non-numeric characters further comprises processor-executable steps to cause the system to:
search, in real-time, of the second model non-numeric characters for MDL compression phrases from the first model smallest grammar.

13. The system of claim 10, wherein the determination of a direction of causality further comprises processor-executable steps to cause the system to:
determine whether the first data distribution causes a delay in the second data distribution or the second data distribution causes a delay in the first data distribution, wherein:
the first data distribution causes the delay in the second data distribution in a case that the first data distribution causes the second data distribution, and
the second data distribution causes the delay in the first data distribution in a case that the second data distribution causes the first data distribution.

14. A computer-implemented method comprising:
receiving a first data distribution for a first variable;
determining a first data optimum number of bins for the first data distribution;
creating a first model for the first data distribution using the first data optimum number of bins;
receiving a second data distribution for a second variable;
determining a second data optimum number of bins for the second data distribution;
creating a second model for the second data distribution using the second data optimum number of bins;
applying the first model to the second data distribution to calculate a smallest descriptive size of the second data distribution given the first model;
applying the second model to the first data distribution to calculate a smallest descriptive size of the first data distribution given the second model; and
determining a causal direction between the first variable and the second variable based on the application of the first model and the second model.

15. The computer-implemented method of claim 14, further comprising:
determining a source of the first data distribution is under attack or a source of the second data distribution is under attack based on the determined causal direction.

16. The computer-implemented method of claim 14, wherein application of the first model to the second data distribution and application of the second model to the first data distribution is via a Kolmogorov complexity algorithm.

17. The computer-implemented method of claim 14, wherein the first data distribution is a time series and the second data distribution is a time series.

18. The computer-implemented method of claim 17, further comprising, prior to application of the first model and application of the second model:
converting one or more values in the first model to non-numeric characters;
compressing the first model non-numeric characters to generate a first model smallest grammar;
converting one or more values in the second model to non-numeric characters; and
compressing the second model non-numeric characters to generate a second model smallest grammar.

19. The computer-implemented method of claim 18, wherein application of the first model further comprises:
applying the first model smallest grammar to the second model non-numeric characters to calculate the smallest descriptive size of the second data distribution given the first model smallest grammar.

20. The computer-implemented method of claim 14, wherein the direction of causality is determined to be:
the first variable causes the second variable in a case that:
K(X)+K(Y|X)<K(Y)+K(X|Y); and
the second variable causes the first data variable in a case that:
K(X)+K(Y|X)>K(Y)+K(X|Y);
wherein K(X) is the first data optimum number of bins, K(Y|X) is an output of the application of the first model to the second data distribution, K(Y) is the second data optimum number of bins, and K(X|Y) is an output of the application of the second model to the first data distribution.
